(19) United States
(12) Patent Application Publication
(10) Pub. No.: US 2011/0124326 A1
(43) Pub. Date: May 26, 2011

(54) Locator for finding lost or misplaced objects

(76) Inventor: Susan Leeds Kudo, Pacific Palisades, CA (US)

(21) Appl. No.: 12/592,254

(22) Filed: Nov. 21, 2009

(51) Int. Cl. H04M 3/00; G08B 1/08

(52) U.S. Cl. 455/420; 340/539.13

(57) ABSTRACT

A network based method and system (apparatus) for locating remote objects which have become lost, misplaced or stolen. An iPhone-like “application” interrogates a low duty cycle locator device with a transceiver and GPS chip. The user is alerted via phone message (call and/or text). The locator device is interrogated via a telephony capable computer server. The user checks on a website to view a map with the coordinates of the missing object displayed. An automatic computer-based method of interrogating the locator allows for extremely small duty cycles (milliseconds) while a missing location may become available every minute, five minutes, or ten minutes, for example.

### FIELD OF THE INVENTION

The invention relates to the remote locating of objects to which the “locator” is attached.

This invention relates to GPS (Global Positioning Satellite) location determination.

This invention relates to an application which is suitable for “I-Phone®”-like cell phones in conjunction with the very low power locator apparatus.

### BACKGROUND OF THE INVENTION

It is easy to lose or misplace objects such as car/house keys, eyeglasses, women's pocketbooks/purses including one-of-a kind valuable objects. One such misplacement/lose occurs very locally, such as in the home. Another type of misplacement/lose occurs when outside the home.

The solution to the in-home lost object typically involves an application of a buzzer or sounding device in the attached finder. Lose or misplacement outside the home calls for a more sophisticated location method.

In all of these considerations one must be aware of size, weight and power requirements for the “locator.” The locator may be attached to a small object such as a set of keys, or, eyeglasses. It could also serve as an attachment to a dog's collar in the event a dog ran off or was taken.

It would be desirable, in conjunction with a “locator apparatus' attached to the object to be located, to have an I-phone® or I-phone-like cell phone application available, which may be used to locate the lost object. Whenever reference is made to an I-phone®, that reference herein automatically includes any I-phone-like cell phone.

While automatic methods for finding such objects as cell-phones exist, a more general type of locator would be desirable to locate any lost object. The object is, of course, attached to the locator, herein.

### SUMMARY OF THE INVENTION

The invention utilizes a server which is telephony capable as part of a network based system. A locator device, or, locator devices are attached to objects one wishes to locate, upon their being lost, misplaced or stolen.

An iPhone or iPhone like mobile device utilizes an application, i.e., a specified computer program, fixed in a media, to interrogate a telephony capable server which in turn calls the locator device which contains a mobile device transceiver, known in the arts, and which in turn, interrogates an on-board GPS (global positioning satellite) chip. The information is returned to the telephony based server, which then pulls up a map depending where the GPS coordinates latitude and longitude show the “missing” locator to be. A telephone call/text message is placed to the user which alerts the user to check on an internet work station.

From an internet web-based computer terminal (i.e., workstation), the user can log in to his/her account and see where the missing locator device, with its attached object, are located, on a scalable map (with zoom capabilities).

The invention utilizes a very low duty cycle receiver-transmitter with an associated low power GPS ‘chip,’ all operating within a reduced function cell-phone, without speech encoding or decoding capability. The reduced cell-phone functionality needs to be able to transmit the simple data: GPS coordinates. An internal timer partially wakes up the invention's receiver for a time window during which the receiver may receive a ‘total’ wake up call.

The invention is woken-up via a call to its cell-phone-based simple receiver. Upon wakening, the apparatus activates a low-power GPS-reading chip, which then transmits the GPS coordinates along with device identification number to the caller.

### BRIEF DESCRIPTION OF THE DRAWINGS

For a more complete understanding of the present invention, and the advantages

thereof, reference is now made to the following descriptions taken in conjunction with the accompanying drawings, in which:

FIG. 1 shows the basic network architecture for the locator system (i.e., “locator”);

FIG. 2 shows the locator network system as used;

FIG. 3 illustrates the process of registering each locator device;

FIG. 4 shows the always on partial wake-up timer and its independent battery and its on-off switch, for an embodiment of the invention; and

FIG. 5 shows the functional actions versus time when waking up the locator, for a preferred embodiment of the invention.

### DETAILED DESCRIPTION OF THE BEST MODES

The following description is of the best mode presently contemplated for carrying out the invention. This description is not to be taken in a limiting sense, but is merely made for the purpose of describing the general principles of the invention.

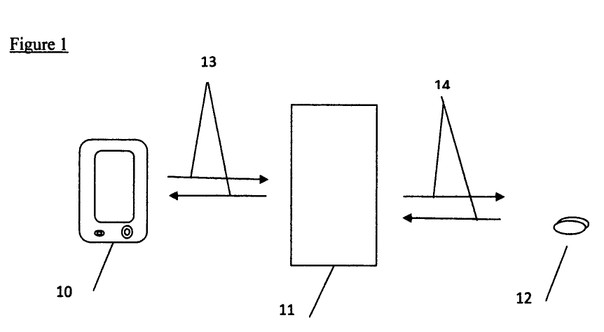

FIG. 1 shows the basic network architecture for this locator. The mobile device's (i.e., the cell phone's), application 10 contacts the telephony server 11, utilizing “http/sockets,” 13 to request a location for a locator device. The telephony 14 server 11 initiates data communications via phone/modem (not shown, typically a “board” internal to the telephony capable server 11). The locator device 12 answers the call from the telephony 14 capable server 11. The telephony 14 capable server 11 sends a request location command to the locator device 12. The locator device 12 responds sending ID (identification of the locator device) and GPS (Global Positioning Satellite to the telephony 14 capable server 11 The telephony 14 capable server 11 then terminates the call.

The telephony 14 server 11 processes the GPS coordinates data utilizing a web application. The web application (not shown), residing in the telephony 14 capable server 11 returns latitude and longitude information superimposed on a map covering those GPS-derived co-ordinates. The telephony 14 capable serve 11, acting as host to the web application (not shown) responds to the mobile device 10 via http 13.

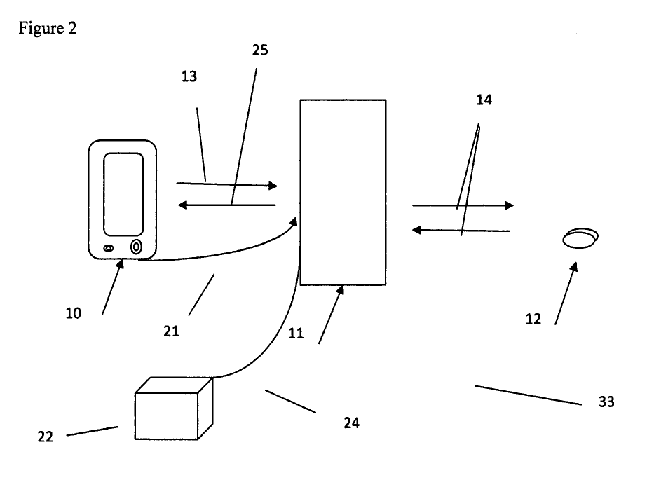

FIG. 2 shows a network configuration similar to that of FIG. 1, except that now there is an internet workstation present 2 and there is a voice/text link from the telephony 14 enabled server 11 to the mobile device 10, instead of the http link (FIG. 1, 13) from the telephony 14 enabled server 11 to the mobile device 10.

Instead of sending data directly to mobile device 10 “application”, i. e. dedicated computer code, fixed in a media (not shown), residing on the mobile device 10

FIG. 2 also shows a second http link 21 from the mobile device 10 to the telephony 14 capable server 11. This later is used when the user checks the “application”'s , or dedicated computer code's (fixed in a media [not shown] residing on the mobile device) website. This second http link 21 may be run through the existing http link 13.

The user logs into his account (login) to see the global positioning satellite's coordinators as passed by the locator device 12.

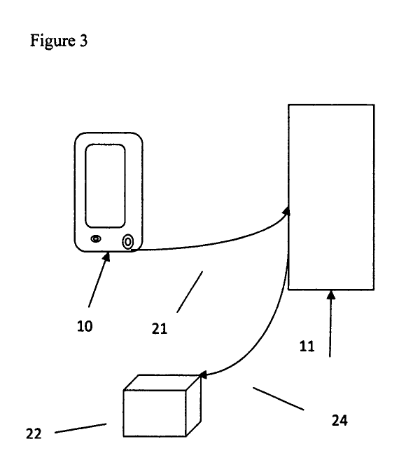

In FIG. 3, the process of registering locator devices 12 onto the above described locator network 33 is as follows: (1) the user purchases locator device(s) 12 and goes online to register it (them); (2) the user creates and then logs into an account; (3) the user supplies web application with the locator device's 12 identification (ID), and optionally, the type of item attached to the locator device 12 is also specifiable; (4) the web application stores user/locator device 12 information in its database, and, it marks, in its data base, the locator device(s) 12 as active.

The invention utilizes a very low duty cycle receiver-transmitter with an associated low power GPS ‘chip,’ all operating within a reduced function cell-phone, without speech encoding or decoding capability. The reduced cell-phone functionality needs to be able to transmit the simple data: GPS coordinates.

An internal timer partially wakes up the invention's receiver for a time window during which the receiver may receive a ‘total’ wake up call. The invention is woken-up via a call to its cell-phone-based simple receiver. Upon wakening, the apparatus activates a low-power GPS-reading chip, which then transmits the GPS coordinates along with device identification number to the caller.

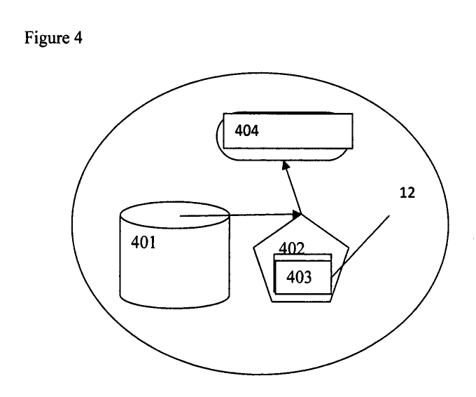

FIG. 4 shows the always on partial wake-up timer and its independent battery and its on-off switch, for an embodiment of the invention.

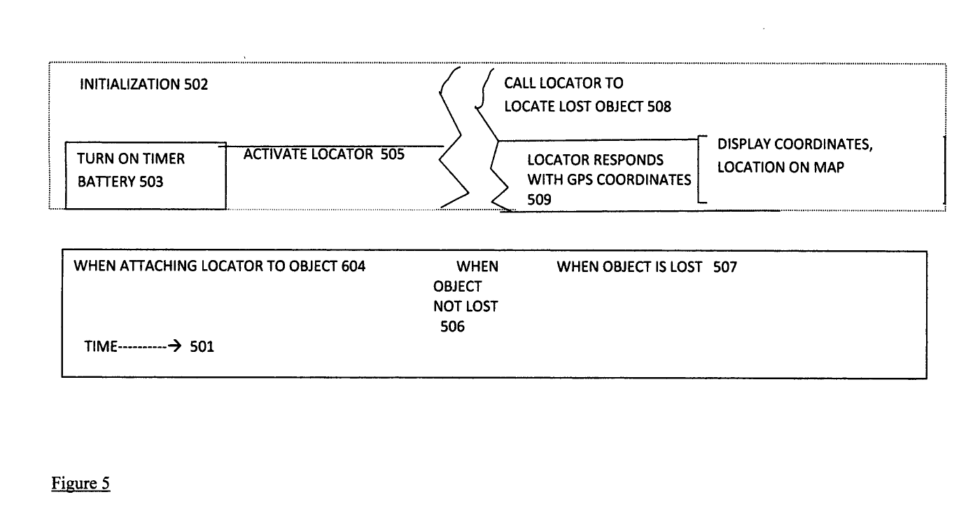

FIG. 5 shows the functional actions versus time when waking up the locator, for a preferred embodiment of the invention.

FIG. 4 is used to show the overall duty cycle which is controlled by a timer 402 which operates off its own very small and light-weight battery 403. One might compare this aspect to a very small watch battery and a very small and light weight timer.

When the timer 402, which stays on continuously powered by its separate battery 403, allows the receiver mechanism to turn on periodically, the main battery 401 is brought on-line and powers up the receive section of the locator. Shown as 404 is the other electronics of the locator, not further designated or shown: namely: antenna, transmit-receive switch, band filter, mixer (down-converter) with local oscillator, intermediate frequencies (IF) amplifiers, frequency modulation (FM) detector, adaptive receiver and links “A and “B” to the GPS chip and to the buffering functionality, respectively. These other electronics correspond to known-in-the-arts mobile telephone receiver (or transceiver).

The time periodicity when the timer 402 turns on the main battery 401 is settable. For example, the locator might be placed in an active receive mode for 5 minutes every hour. That requires an incoming call to be made to it within that five minute interval beginning on each hour. The setting of this feature depends on the desirability of keeping the duty cycle low while having the convenience of initiating a location search for the missing object attached to the locator.

The timing and periodicity may be set at the factory, or, in conjunction with a chart indicating how often to recharge the main locator battery 401, it may be set by the locator owner.

FIG. 5 is a diagram of the function versus time. Time 501 is shown at the bottom horizontal layer. When the object is first taken out of its box and attached 504 to an object to be located, the process of initialization 502 begins. The timer battery 503 is turned on 503. And an initial call to the locator is made to activate it 505.

Activating the locator 12 and registering it, as above, then allows the locator device 12 to be used.

When the object is not lost 506, nothing happens beyond the periodic turning on, for a limited period, of the locator receive functionality. Eventually, the locator main battery 401 must be recharged. This might be shown by a low power led (light emitting diode) flashing for a while when the main battery power is below a certain level, as known in the arts.

If the object attached to the locator is lost 507, a call is placed to the locator 12 and the locator responds with the GPS coordinates 509. The coordinates are displayed on a map display.

Two separate small, low weight batteries which utilize a low duty cycle locator device, based on a low duty cycle for its main battery. This is accomplished by utilizing a low power prompting timing circuit; and prompting an on-state for the locating device transceiver, occasionally but regularly. For example, the timing circuit may turn the locating device transceiver on for five minutes in every hour, at the beginning of the hour. Another aspect of this preferred invention is having the telephony enabled computer server repeatedly call the locator device corresponding to time-on duty cycle; keeping the time-on duty cycle information in the information data base, for each registered user of the locator method.

The time-on duty cycle may be the same for each locator device.

The approach to choosing the battery size and weight is according to the number of days it is requested that the locator device can remain active.

The locator system (apparatus and method) may utilize accurate timing information available from a global positioning satellite and/or the National Bureau of Standards so as to minimize the duty cycle of the on-time for the locator device(s).

This would allow for the smallest battery sizes for the longest periods of time. Also, for example, with interrogation of the transceiver for a millisecond every 10 seconds, would allow for almost immediate contact, while still maintaining a very low duty cycle.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

1. A method for locating a remotely located missing object, comprising:
attaching object to a locator device;
interrogating the locator device from a mobile cell phone device by utilizing a specific computer program, fixed in a media, wherein a telephony enabled computer server is activated via an http signal from the mobile cell phone device and wherein the locator is called by telephony;
utilizing a locator device wherein the locator device includes a mobile phone like transceiver, known in the arts, and a very small global positioning satellite chip;
responding to the telephony enabled computer server, the locator device turns on the global positioning satellite chip, receiving position location information from the global positioning satellite and transmitting said information back to the telephony enabled computer server together with the locator device's unique identification;
receiving back global positioning satellite determined latitude and longitude information and locator's device unique identification, the telephony enabled computer server, checking its registered users database with the registered users locator device unique identification, then initiates a call, voice and/or text, to the users registered iPhone or iPhone-like mobile phone (i.e., specific computer program fixed in a media enabled); and
prompting the user to log on to an interne computer workstation, utilizing user's unique account identification access wherein user views a scalable map with missing object's global positioning coordinates marked.

2. The method of claim 1, further comprising:
utilizing two separate small, low weight batteries;
utilizing a low duty cycle locator device, which utilizes a low duty cycle for its main battery;
utilizing a low power prompting timing circuit; and
prompting an on-state for the locating device transceiver, occasionally but regularly.

3. The method of claim 2, further comprising:
having the timing circuit turn the locating device transceiver on occasionally but regularly, the on-time on being five minutes in every hour, at the beginning of the hour;

4. The method of claim 1, further comprising;
having the telephony enabled computer server repeatedly call the locator device corresponding to time-on duty cycle;
keeping the time-on duty cycle information in the information data base, for each registered user of the locator method.

5. The method of claim 4, further comprising;
timing the time-on duty cycle so that it is the same for each locator device.

6. The method of claim 2, further comprising;
sizing the battery size and weight according to the number of days it is requested that the locator device can remain active.

7. The method of claim 6, further comprising;
utilizing accurate timing information available from a global positioning satellite and/or the National Bureau of Standards so as to minimize the duty cycle of the on-time for the locator device(s).

8. The method of claim 6, further comprising;
interrogating, by the telephony capable computer server, more continuous, such as for a few milliseconds every minute; wherein a very small battery may be used and the lifetime of the battery extended.

9. A system (apparatus) for locating a remotely located missing object, comprising:
a locator device attachable to a potentially missing object;
a mobile cell phone device having a specific computer program, fixed in a media, wherein an activatable a telephony enabled computer server is activated via an http signal from the mobile cell phone device and wherein the locator is called by telephony;
a locator device wherein the locator device includes a mobile phone like transceiver, known in the arts, and a very small global positioning satellite chip;
the activatable telephony enabled computer server wherein the server activates the locator device which turns on the global positioning satellite chip, the chip having received position location information from the global positioning satellite and transmitted said information back to the telephony enabled computer server together with the locator device's unique identification;
global positioning satellite determined latitude and longitude information and locator's device unique identification having been received by the telephony enabled computer server, wherein said server checks its registered users database with the registered users locator device unique identification, then initiates a call, voice and/or text, to the user's registered iPhone or iPhone-like mobile phone (i.e., specific computer program fixed in a media enabled); and
a scalable map with missing object's global positioning coordinates marked, wherein said scalable map is viewed by the user having been prompted by the user to log on to an internet computer workstation, utilizing user's unique account identification access wherein user views.

10. The system (apparatus) of claim 1, further comprising:
two separate small, low weight batteries;
a low duty cycle locator device, which utilizes a low duty cycle for its main battery;
a low power prompting timing circuit wherein the on-state for the locating device transceiver, is prompted occasionally but regularly.

11. The system (apparatus) of claim 1, further comprising:
the on-time on being five minutes in every hour, at the beginning of the hour.

12. The system (apparatus) of claim 1, further comprising:
the telephony enabled computer server wherein said server repeatedly calls the locator device corresponding to time-on duty cycle and wherein said time-on duty cycle information is in the information data base, for each registered user of the locator method.

13. The system (apparatus) of claim 1, further comprising:
a duty cycle timed so that it is the same for each locator device.

14. The system (apparatus) of claim 1, further comprising:
batteries wherein their size and weight is chosen according to the number of days that the locator device can remain active.

15. The system (apparatus) of claim 1, further comprising:
accurate timing information available from a global positioning satellite and/or the National Bureau of Standards wherein said information is used to minimize the duty cycle of the on-time for the locator device(s).

16. The system (apparatus) of claim 1, further comprising:
an interrogation schedule for the locator device, interrogated, by the telephony capable computer server, wherein the locator device is interrogated more continuously, such as for a few milliseconds every minute; wherein a very small battery may be used and the lifetime of the battery extended.
